(19) United States
(12) Patent Application Publication
(10) Pub. No.: US 2007/0260558 A1
(43) Pub. Date: Nov. 8, 2007

(54) Methods and systems for secure transactions with electronic devices

(76) Inventor: Thomas F. Look, Ham Lake, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/787,424

(22) Filed: Apr. 16, 2007

Related U.S. Application Data
(60) Provisional application No. 60/792,845, filed on Apr. 17, 2006.

(51) Int. Cl. H04K 1/00

(52) U.S. Cl. 705/76

(57) ABSTRACT

Methods and systems for conducting transactions using an electronic device are provided. For example, a mobile electronic device such as a mobile phone or the like can be used to purchase goods from a merchant. An exemplary method comprises the steps of selecting a payee, generating a secure two-dimensional code comprising transaction information, providing the secure two-dimensional code to the payee, and authorizing a payment to the payee.

### RELATED APPLICATIONS

This application claims the benefit of U.S. Provisional Patent Application having Ser. No. 60/792,845 filed on Apr. 17, 2006, entitled “Methods for Secure Mobile Phone Transactions,” the entire disclosure of which is incorporated herein by reference for all purposes.

### TECHNICAL FIELD

The present invention is directed to methods and systems for conducting secure business transactions with electronic devices such as mobile handheld electronic devices.

### BACKGROUND

Credit cards, including debit cards, check cashing cards, other financial transaction cards and identification cards, are well known and have been successfully utilized for conducting business transactions, security, and identification verification of individuals for many years. Such credit cards, debit cards, check cashing cards, financial transaction cards, and identification cards, among others are typically constructed from a durable material having a rectangular shape. Transaction cards usually contain specific information that relates to identification or financial information of the authorized user. Such information may be embossed on the transaction card as raised alphanumeric characters or, contained in a magnetic strip or electronic storage device attached to or embedded within the transaction card. Information often consists of alphanumeric characters corresponding to the individual's financial institution account number, identifying PIN number, the transaction card's expiration date, and other limited amounts of personal data. Some transaction cards include a picture of the authorized cardholder printed on the face or obverse thereof. Each type of transaction card typically is intended to communicate unique data for a particular financial institution, retail loyalty program or the like, as well as, of the authorized transaction cardholder.

Individuals typically use transaction cards in payment transactions for the purchase of goods and services of every nature and kind at physical locations; by providing the information found on transaction card over the telephone; and, over the Internet. In use, an individual provides a transaction card for payment by providing it to a sales person or clerk; or, by swiping the transaction card through a reader or electronic point of sale reading and communication device. In some instances, such as with bank debit cards, the individual must provide a PIN Number to consummate the transaction. If a transaction card is lost or stolen, it is often possible for a wrongdoer to utilize it for cash advances and purchases prior to the time it is reported lost or stolen by the authorized user and cancelled. This is because credit card transactions are typically batched for processing once a day, which gives wrongdoers a window of up to 24 hours before the card is cancelled. A sales person or clerk may ask for alternative forms of identification that may also be in the wrongdoer's possession or, may ask for a signature comparison to the signature appearing on the transaction card and easily copied by the wrongdoer or, the sales person or clerk processing the transaction may do nothing at all to verify that the individual attempting to utilize the transaction card is the person authorized to do so. With the increase of fraud and identity theft, providers of goods and services, financial institutions and individuals are paying directly and indirectly for the losses incurred by such theft and thereby have a growing desire and need in privacy and security for the means by which they provide financial informational and utilize transaction cards.

In response to the security problems related to transaction cards there is an emerging change from using transaction cards for business transactions to using mobile devices such as phones and similar personal handheld electronic devices for conducting such business transactions. One problem is that the electronic devices are often not secure enough. Moreover, a paper trail to memorialize or validate the financial transaction is typically not available. However, the potential for identity theft and fraudulent use of transaction cards provide a desire for a more secure method of conducting business transactions.

### SUMMARY

The present invention thus provides methods and systems for securely transferring data through mobile devices to be used in transactions that involve payments or data that requires high security. Any mobile or portable devices that function to store and/or share data can be used in accordance with the present invention. Additional specific examples include PDA's, Blackberry type devices, video/dvd players or recorders, game consoles, audio or music players such as MP3 players and the like. Methods in accordance with the present invention are secure, simple and easy to use. Such methods minimize or prevent compromising the system by forgery, identify theft or any other means of sending or receiving erroneous data because the code used is secure. Methods to accomplish this task are available including encrypted data streams, however the present invention uses a coding system that does not use public and private keys for security but rather advantageously employees proprietary two-dimensional code construction as an image graphic file, such as a BMP file, that contains the private data.

In one aspect of the present invention, a method of conducting a transaction using an electronic device is provided. For example, a mobile electronic device such as a mobile phone or the like can be used to purchase goods from a merchant. The method comprises the steps of selecting a payee, generating a secure two-dimensional code comprising transaction information, providing the secure two-dimensional code to the payee, and authorizing a payment to the payee. The secure code can be provided to the payee by displaying the code on a display of the mobile phone or the code can be transmitted electronically to the payee.

In another aspect of the present invention, an electronic device that can be used to conduct a transaction is provided. The electronic device comprises a unique identifier stored in memory of the electronic device for uniquely identifying the electronic device, a database comprising public information stored in memory of the electronic device, a database comprising private information stored in memory of the electronic device, a code generator for generating a secure two-dimensional code comprising transaction information, and means for providing the secure two-dimensional code to a payee or financial Institution.

In yet another aspect of the present invention, a mobile phone is provided. The mobile phone comprises a unique identifier stored in memory of the mobile phone for uniquely identifying the mobile phone, a database comprising public information stored in memory of the mobile phone, a database comprising private information stored in memory of the mobile phone, a code generator for generating a secure two-dimensional code comprising transaction information, and a display screen for providing the secure two-dimensional code to a payee or financial Institution.

### BRIEF DESCRIPTION OF THE DRAWINGS

FIG. 1 is a schematic view of system for conducting secure transactions in accordance with the present invention; and

FIG. 2 is a schematic illustration of exemplary methods of conducting transactions in accordance with the present invention.

### DETAILED DESCRIPTION

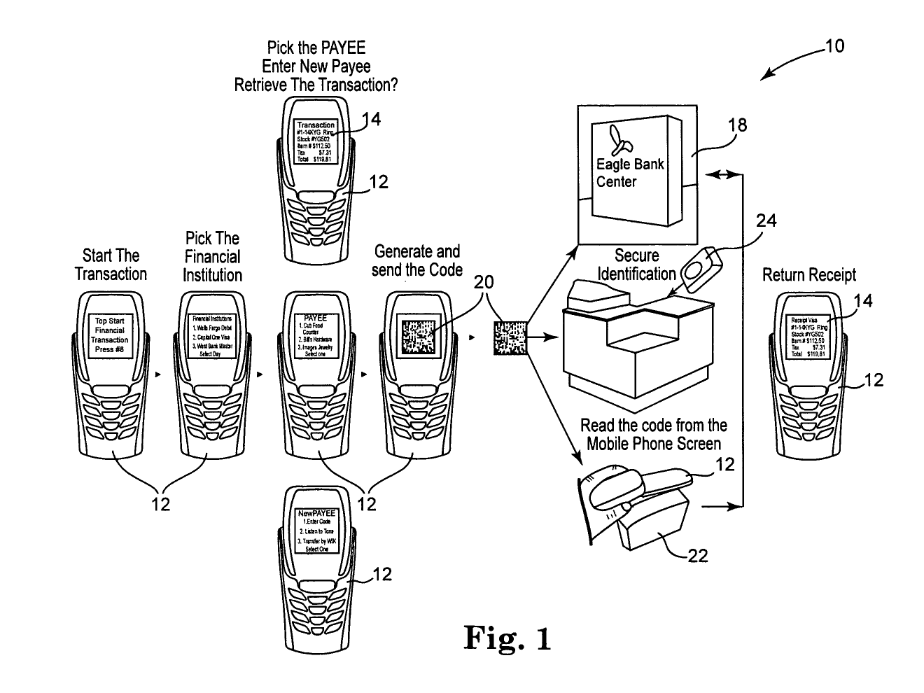

In FIG. 1, a system 10 for conducting transactions in accordance with the present invention is schematically illustrated along with associated methods. The system 10 includes mobile phone 12 having viewing screen 14, payee 16, and financial institution 18. In accordance with the present invention, the mobile phone 12 can be used to conduct a transaction between a user of the phone and the payee 16. Specifically, the mobile phone 12 includes programming for generating a secure two-dimensional code 20 that can be provided to the payee 16 and used to authorize or validate a transaction between the payee and a user of the mobile phone 12 by securely exchanging information. The system 10 also preferably includes a reading device 22 for reading the secure two-dimensional code 20 and may include a secure identification device 24 such as a fingerprint reader or the like. The user of the mobile phone 12 is typically one who has the authority to conduct a financial or secure transaction with a desired payee. The payee is typically the recipient of the financial or secure transaction such as a retail store, an online vendor, a secured documents government agency or the like. A financial institution typically refers to a banking or financial account holder of a user that processes and clears financial transactions.

Techniques for securing data, such as personal data or biometric data, are well known. For example, two-dimensional matrix coding technology uses so-called two-dimensional bar code symbologies. A two-dimensional symbology typically includes a matrix that occupies a uniform amount of space having a generally rectangular or square shape. Instead of bars and spaces, as used in 1-dimensional bar codes, round or square marks disposed at particular rows and columns of the matrix correspond to the information being conveyed. As a result, a two-dimensional matrix symbology can include significantly more data within a given volume of space than a conventional one-dimensional bar code.

Software usable in accordance with methods and systems of the present invention preferably uses two-dimensional bar code encoding and decoding algorithms. Typically, in these techniques, information is encoded by an appropriate technique such as by encoding the information into Reed-Solomon blocks. A data matrix that contains a plurality of data cells is then generated from the encoded information. Next, the data matrix is converted to a bitmap image, in the form of a symbol, and the image is printed on an object, label, box, etc. For example, symbols of this type are now in common usage in various applications, such as inventory control, point of sale identification, or logistical tracking systems. Any known or developed two-dimensional bar coding system is contemplated including the Vericode™ technology commercially available from Veritec Inc. of Golden Valley, Minn., the assignee of the subject invention, the VSCode™ technology also available from Veritec Inc., the Data Matrix™ code, the Code One™ code or any other. With respect to the Vericode™ and VSCode™ technologies, reference is made to U.S. Pat. No. 5,612,524, U.S. Pat. No. 5,331,176, U.S. Pat. No. 4,972,475, and U.S. Pat. No. 4,924,078, the entire disclosures of which are incorporated herein by reference for detailed description of such codes and methods and software for encoding and decoding digital information as blocks in an array as a two-dimensional bar code.

Data to be encoded can be converted to a binary stream of ones and zeros. The binary information can then be further encrypted or otherwise processed to allow Error Detection and Correction (EDAC). Reed-Solomon error correction, now used by almost all 2D bar codes, is a byte-correcting scheme that is widely used for digital storage applications in fields such as telecommunications, for example. By this technique, Reed-Solomon error correcting codewords are incorporated along with data codewords to form an integrated message. For example, the encrypted binary stream (or data encoded in any other form) can be distributed to a 2-dimensional symbology such as a matrix array. Any linear, area, or stacked symbology can be used. A linear symbology as used herein, refers to a symbology that uses one or more rows of bars and spaces such as a bar code or the like. An area symbology as used herein, refers to any symbology, such as those commercially known under the trade names VeriCode™ or VSCode™ or Data Matrix™ or Code One™ or the like, that employs a matrix of data cells, rather than one or more rows of bars and spaces. A stacked symbology, as used herein, refers to any symbology, such as PDF 417, that generally employs plural adjacent rows of symbols, each row having several characters defined by groups of multiple-width bars and spaces. As an example, the encoded data can be used to create a matrix of VeriCode™ cells. This can be done by digitizing the encoded data into binary bit form and processed by a software algorithm to generate a code. Such techniques are known in the art such as described in the above-identified U.S. patents. Reference is also made to copending U.S. provisional patent application No. 11/121,762, filed May 3, 2005 to David Wood, the entire disclosure of which is also incorporated herein by reference, which is directed to storing digital code information in a memory device as a security feature.

An exemplary software application in accordance with the present invention preferably comprises two parts (an executable to perform the required tasks and a database of private data) but they may exist as a single entity on the mobile phone or electronic device. The executable is preferably constructed and encrypted to prevent decompiling using techniques well known in the art. The executable preferably contains a usage license tied to the mobile phone or electronic device unique numbers. The executable extracts data from a public database and a mobile phone private database associated with the user. The private database is preferably highly encrypted using the mobile phone unique numbers, for example, as encryption agents. This method ties the executable and the private database to each other and the mobile phone.

In accordance with the present invention, a user initiates a transaction by pressing a key, series of keys, or uses a voice command on the mobile phone to start the process and may enter a pin number, security code, or the like to authorize a desired transaction(s) to start. The user typically selects a financial institution from a list of authorized sources for conducting the transaction, preferably from a drop down list or the like on the mobile phone. The application also preferably comprises a pull down list of potential payees to identify the correct payee. If this were the first transaction with a given payee the payee identifier could be added manually or by a two-way communications method (wired or wireless). The executable on the mobile phone generates the secure two-dimensional code, preferably as an electronic signal, containing the desired transaction information or data to be sent to the payee or directly to the financial institution or both. Transaction information or data refers to information, data, signals, or the like that is used to conduct a transaction in accordance with the present invention. The mobile phone preferably uses Wireless mobile, Bluetooth, Wifi, infrared, sound transfer or any other available means to transfer the code to the payee for close range transfer or Wireless mobile to transfer the code to the financial institution (long range). The payee's data will be in the code sent by the user and included in the original coded image graphic. The process to identify the unique receiver for the intended financial transaction will require some cross communications between the user and the payee either in real time or part of a previous download to the user's mobile phone or manual entry. The transactional financial data can be included in the cross communication method and displayed on the user's mobile phone or send directly to the financial institution.

The payee and/or financial institution decodes the secure two-dimensional code extracting the required transaction information for the particular transaction requirements. For example, the payee can upload transaction information to the selected financial institution of the user to authorize or validate the transaction. The payee electronically communicates with the selected financial institution of the user to implement the transaction. The financial institution may download the requirements for the transaction, including the level of identity required, to the payee. The final step, if required, is typically for the payee to identify the user based on the financial institution requirements and the user to review the transaction and to use a pin number, fingerprint, or other means to provide the final authorization. When the transaction is complete, a receipt can be generated by the payee or the financial institution in paper as well as electronic form as desired.

The secure two-dimensional code is printable and readable as an image graphic using an optical code reader. The code is also readable on the mobile phone screen using an optical code reader. The advantage is for applications that are better suited to optically reading the code rather than an all electronic technique of data transfer which can be used as well in accordance with the present invention. Reading the code from the mobile phone can eliminate the need to identify the name and demographic data of a user because that information is supplied directly to the financial institution.

Transaction information or data exchanged between a user, payee, and/or financial institution generally includes public and private data. Examples of user public data include personal and demographic information such as data that uniquely identifies the user and is available on the mobile phone. The payee name, demographic data, financial transaction account number and financial data can be included as public data. The user can select the payee name and demographic data from a drop down list on their mobile phone, for example, from data presented to the user's mobile phone via two-way communications or a downloaded file of potential vendors or manual entry. The payee name and demographic data could also be entered for the first time using a tonal system, such as that produced by the key pad, that is provided at the receiver site and monitored by the user's mobile phone and later stored in the drop down list. For mobile phones with cameras, the camera can be used to image a one-dimensional or two-dimensional code with the payee information and an application on the phone can decode and format the data as payee information. The code can be at the point of sale counter or used in paper based advertising to promote a particular payee and make internet or mobile phone purchases easier and more secure. Personal and demographic information can be used for such tasks as mailing a paper receipt, sending an email receipt, or checking against another form of identification. The information is preferably provided to the payee in a form that avoids privacy issues. Other public data includes a time/date stamp that generates a unique transaction code within a time limited period. The time date stamp can be used to preclude intercepting and using the same two-dimensional code at a later time assuming all other safe guards would have failed while at the same time generating a unique transaction code.

Examples of private data include mobile phone unique identification numbers, credit, debit card, or financial institution code(s) to be used in the transaction, finger print data or other biometric data used to identify the sender, facial image data of the sender or a signature graphic, and a pin number or security code known by the sender. Mobile phone unique identification numbers provide a unique identifier combination that singles out the sending phone as the only one usable by the user. Mobile phones and similar devices and service providers have unique numbers that uniquely identify these devices such as the International Mobile Equipment Identity (IMEI), the SIM card Identity number which is embedded and unique, and the service provider unique customer number and the like. The code generator application is preferably tied to the phone that it is originally placed on by using such unique identification numbers as encryption agents, for example. Preferably, the application cannot be moved to a different phone and be usable. Fingerprint, facial image, and signature graphic information are biometric means of uniquely identifying an authorized user of the mobile phone and the owner of the financial credit or debit transaction. The pin number could suffice for small transactions and act as the initiator for generating and sending the code.

The above lists of public and private transaction information are not inclusive of all public and private data that may be desired for a particular transaction and they are representative of a typical application to demonstrate the unique aspects of the secure data transfer method of the present invention. It should be noted that all of the above data does not need to be used for every transaction and such data can be used selectively.

Preferably, the fingerprint, signature, and facial image only exist on the mobile phone and therefore there is no privacy issue. The user only supplies identity data to an application that does not record the identity data but only uses the secure two-dimensional code for the immediate transaction. Every secure two-dimensional code is preferably dependant on the unique identification number for the mobile phone or electronic device so that even if identification data is recorded it is useless after the transaction is over since the transaction is time and date stamped.

Data can be transferred in code form making interception of a code image graphic useless for fraudulent activity because of the inability to extract information from the code image graphic and the time/date transaction number. Even if this could be somehow done in the allotted time frame, the sender identification process would fail.

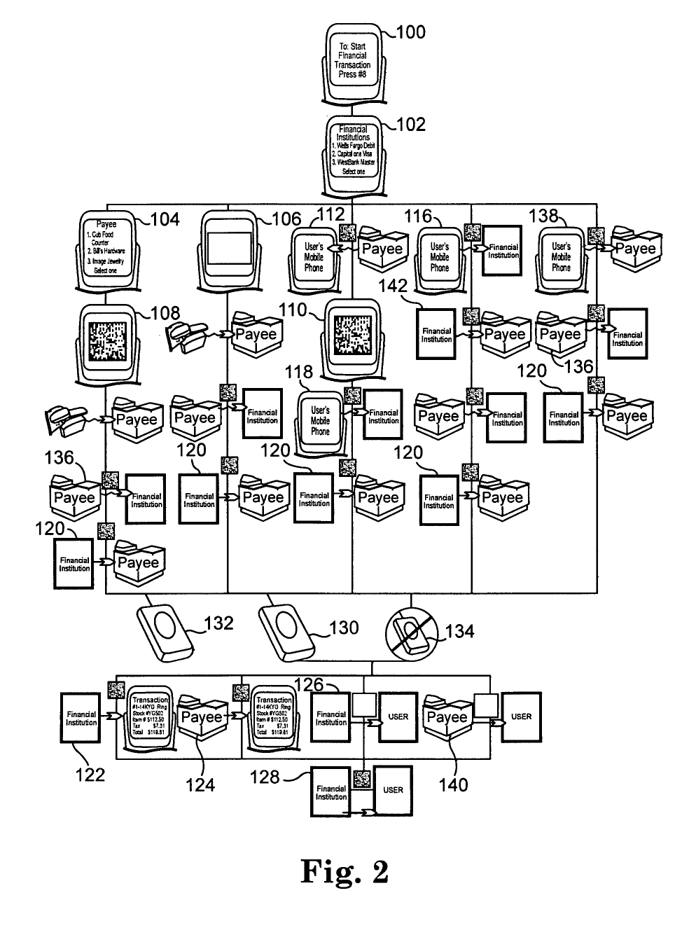

Referring to FIG. 2, a schematic illustration of exemplary methods of conducting transactions in accordance with the present invention is provided. Each element shown in FIG. 2 is described below and represents aspects of conducting transactions in accordance with the present invention.

Reference numeral 100 identifies initiation of a transaction such as financial transaction between a user and payee. The user preferably enters data via a manual entry method such as a keypad to initiates the transaction. Voice recognition and touch screen activation can also be used.

Reference numeral 102 identifies choosing a financial account for that will be used for the transaction. The user can select a financial account institution or provider using a drop down menu entering data via a manual entry method such as the keypad, voice recognition, touch screen, or other means.

Reference numeral 104 identifies choosing a payee, vendor, or merchant, or the like that will be the beneficiary of the transaction. The user can select the payee by using a drop down menu, entering data via a manual entry method such as the keypad, voice recognition, touch screen, or other means. This step is unnecessary if the user elects to provide the user and financial institute information directly to the payee for transaction processing by the payee.

Reference numeral 106 identifies creation of a secure two-dimensional code by the code generator of the application software. The secure two-dimensional code includes financial institution data and could include user data. The secure two-dimensional code is displayed on a display device, such as a screen, of the mobile phone or electronic device.

Reference numeral 108 identifies creation of a secure two-dimensional code by the code generator of the application software. The secure two-dimensional code includes financial institution data and payee data. The secure two-dimensional code is displayed on a display device, such as a screen, of the mobile phone or electronic device.

Reference numeral 110 identifies creation of a secure two-dimensional code by the code generator of the application software. The secure two-dimensional code includes financial institution data, payee data, and financial data. The secure two-dimensional code is displayed on a display device, such as a screen, of the mobile phone or electronic device.

Reference numeral 112 identifies the payee wirelessly sending payee account and financial data to the mobile phone using a secure two-dimensional code. This information will allow the user to directly contact the financial institution to process the transaction.

Reference numeral 114 identifies reading and decoding of the secure two-dimensional code via a mobile phone two-dimensional optical code reader. The code reader images the mobile phone screen, decodes the two-dimensional code and provides the decoded data to the payee. For example, data can be sent to a payee computer at the point of sale/transaction by using a mobile phone two-dimensional optical code reader.

Reference numeral 116 identifies the mobile phone wirelessly sending user financial account information and payee information to the financial institution using a secure two-dimensional code.

Reference numeral 118 identifies the mobile phone wirelessly sending user financial account information, payee information, and financial data to the financial institution using a secure two-dimensional code.

Reference numeral 120 identifies the financial institution transmitting receipt data of the transaction to the payee using a secure two-dimensional code. For example, receipt data can be sent to a point of sale system or a transaction card terminal. For transactions that require additional user verification, the receipt can include verification instructions.

Reference numeral 122 identifies the financial institution transmitting receipt data of the transaction to the mobile phone using a secure two-dimensional code.

Reference numeral 124 identifies the payee transmitting receipt data of the transaction to the mobile phone using a secure two-dimensional code.

Reference numeral 126 identifies the financial institution printing and providing a paper receipt of the transaction to the user.

Reference numeral 128 identifies the financial institution transmitting all summary data for the user's account with the financial institution to the mobile phone using a secure two-dimensional code. Transmission of specific receipt data may also take place if desired.

Reference numeral 130 identifies where the payee requires the user to provide secure identification such as a pin code or biometric identification or data using such devices as a keypad or fingerprint reader or the like according to requirements of the financial institution.

Reference numeral 132 identifies the user providing secure identification such as a pin code or biometric identification or data using such devices as a keypad or fingerprint reader or the like thereby authorizing the transaction.

Reference numeral 134 identifies the situation where no secure identification is required to authorize the transaction such as all transactions under a predetermined amount.

Reference numeral 136 identifies the payee sending payee financial account data, user financial institution account data, and financial data through a bank transaction card network to the financial institution using a secure two-dimensional code.

Reference numeral 138 identifies the mobile phone wirelessly sending user financial institution account information to the payee using a secure two-dimensional code.

Reference numeral 140 identifies the payee printing and providing the user with a paper receipt of the transaction.

Reference numeral 142 identifies the financial institution transmits user financial account data to the payee using a secure two-dimensional code. For example, receipt data can be sent to a point of sale system or a transaction card terminal.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures. It also should be noted that while the use of a secure two-dimensional code is referenced for many different data transfers, the actual use, limited use or non-use of the code for any given transfer of data may be governed by the financial institution or payee requirements for data transfer security in the given transfer.

What is claimed is:

1. A method of conducting a transaction using an electronic device, the method comprising the steps of:
selecting a payee;
generating a secure two-dimensional code comprising transaction information;
providing the secure two-dimensional code to the payee; and
authorizing a payment to the payee.

2. The method of claim 1, wherein the step of selecting a payee comprises selecting a payee from one or more payees stored in memory of the electronic device.

3. The method of claim 1, wherein the step of selecting a payee comprises entering payee information into memory of the electronic device.

4. The method of claim 1, wherein the transaction information comprises one or more of financial institution account information, public information, private information, and biometric data.

5. The method of claim 1, wherein the step of providing the secure two-dimensional code to the payee comprises displaying the secure two-dimensional code on a display screen of the electronic device.

6. The method of claim 1, further comprising the step of selecting a financial institution for providing payment to the payee.

7. The method of claim 1, further comprising generating a receipt for the transaction.

8. The method of claim 1, further comprising purchasing a consumer product.

9. The method of claim 1, wherein the electronic device comprises a mobile phone.

10. An electronic device that can be used to conduct a transaction, the electronic device comprising:
a unique identifier stored in memory of the electronic device for uniquely identifying the electronic device;
a database comprising public information stored in memory of the electronic device;
a database comprising private information stored in memory of the electronic device;
a code generator for generating a secure two-dimensional code comprising transaction information; and
means for providing the secure two-dimensional code to a payee.

11. The electronic device of claim 10, wherein the database of private information is encrypted using the unique identifier of the electronic device as an encryption agent.

12. The electronic device of claim 10, wherein the database of public information comprises one or more of a payee name, demographic data, and a financial transaction account number.

13. The electronic device of claim 10, wherein the database of private information comprises one or more of a financial account number, biometric data, and a security code.

14. The electronic device of claim 10, wherein the means for providing the secure two-dimensional code to a payee comprises a display screen.

15. The electronic device of claim 10, wherein the means for providing the secure two-dimensional code to a payee comprises a wireless communication device.

16. A mobile phone comprising:
a unique identifier stored in memory of the mobile phone for uniquely identifying the mobile phone;
a database comprising public information stored in memory of the mobile phone;
a database comprising private information stored in memory of the mobile phone;
a code generator for generating a secure two-dimensional code comprising transaction information; and
a display screen for providing the secure two-dimensional code to a payee.

17. The mobile phone of claim 16, wherein the database of private information is encrypted using the unique identifier of the mobile phone as an encryption agent.

18. The mobile phone of claim 16, further comprising a wireless communication device for providing the secure two-dimensional code to a payee.
